(19) United States
(12) Patent Application Publication
(10) Pub. No.: US 2013/0132576 A1
(43) Pub. Date: May 23, 2013

(54) Network Device, Method of Controlling Network Device, and Recording Medium on Which Program for Controlling Network Device Is Recorded

(71) Applicant: Buffalo Inc., Nagoya-shi (JP)

(72) Inventors: Yoshifumi Haba, Nagoya-shi (JP); Hideki Ishii, Nagoya-shi (JP)

(73) Assignee: Buffalo Inc., Nagoya-shi (JP)

(21) Appl. No.: 13/677,323

(22) Filed: Nov. 15, 2012

(30) Foreign Application Priority Data
Nov. 22, 2011 (JP) 2011-254787

(51) Int. Cl. G06F 15/173

(52) U.S. Cl. CPC G06F 15/17306; H04L 61/2007
USPC 709/225

(57) ABSTRACT

An access point AP that is an embodiment of a network device assigns an IP address to a terminal connected to the access point AP itself. The access point AP includes: a distributing unit 118 that distributes the IP address to terminal and has functionality to notify the terminal to transmit all access requests to the network device AP itself; a distribution control unit 120 for switching the functionality of the distributing unit 118 to be operative on the basis of the generation of a predetermined starting event; an accepting unit 112 for accepting any given access request from the terminal; and a notifying unit 114 for notifying the requesting terminal of information for accessing the network device AP when the accepting unit has accepted the request, regardless of the content of the request.

### BACKGROUND OF THE INVENTION

1. Field of the Invention

The present invention relates to network devices employed connected to a network, and to control methods, and recording media on which control programs are recorded, for controlling such network devices.

2. Description of the Related Art

For network devices to carry out Internet Protocol (IP) communications with each other in a network, it is necessary for the devices each to comprehend the IP addresses of the other communication partners. The reason is that it is impossible to designate a transmission destination without the IP address of the communication partner being known.

Methods for figuring out the IP address of a communication partner include, for example, techniques such as examining the network configuration to comprehend the address, in a manual operation based on knowledge about the network, and installing set-up software in a terminal that will be connected to a network device. (Reference is made to Japanese Unexamined Patent Application Publication No. 2005-107707).

In the case of figuring out an IP address by a manual operation, however, for a user with an insufficient level of knowledge relating to the network the address-comprehending operation itself will present difficulties, and even a user with a high-level of knowledge concerning the network will be faced with a cumbersome, time-consuming job.

Meanwhile, in the case of using set-up software, it is typical to distribute the software by means of media such as CDs. For vendors, with distribution of such media there is room for improvement from a cost aspect, and for users, the operations of preparing of the media and installing the software are doubtless cumbersome jobs.

### BRIEF SUMMARY OF THE INVENTION

An object of the present invention, brought about taking the above-described circumstances into consideration, is to make available a network device, and a control method and a control program for the network device, that enable IP communications among network devices to be executed even for users without advanced knowledge, and even without bringing software into the picture.

In the following, various means effective for resolving the issues discussed above will be described, with advantages and effects being indicated as necessary.

A network device according to the present invention is a network device for use connected to a network, the network device comprising: a distributing unit for assigning an IP address to a terminal being another network device connected to said network device, and distributing the assigned IP address to the terminal, and for notifying the terminal to transmit all access requests to said network device itself; a distribution control unit for actuating the distributing unit based on the generation of a predetermined starting event; an accepting unit for accepting any given access request from the terminal; and a notifying unit for, when the accepting unit has accepted an access request from the terminal after the distributing unit has been actuated, notifying the terminal of information for accessing said network device itself, regardless of the content of the access request.

With the configuration described above, when a predetermined starting event is generated, the distribution control unit that the network device provides renders the functionality of the distributing unit operative. The distributing unit then distributes an IP address to a terminal that is another network device, whereby an IP address is assigned to the terminal. The distributing unit notifies the terminal having the IP address to transmit all access requests to the network device, and therefore the accepting unit accepts any given access request from the terminal. After an acceptance, the notifying unit notifies the terminal of information for accessing the network device, regardless of the content of the access request from the terminal. According to the information with which it has been notified, the terminal is able to comprehend the IP address and related information for accessing the network device. As described above, the network device assigns an IP address to the terminal and thus comprehends the IP address of the terminal. Therefore, the network device and the terminal are able to comprehend their partner's IP address. Accordingly, the terminal's exploiting the given information enables IP communications between network devices to be executed even for users without advanced knowledge, and even without bringing software into the picture. By IP communications between network devices, for example, a terminal can be operated to change the settings of a network device, or data that a network device holds can be acquired from the network device.

In the network device according to the present invention, when the accepting unit has accepted a name-resolving request from the requesting terminal as the given access request, the notifying unit notifies the requesting terminal of information including the IP address of the network device itself as the information.

With the configuration described above, if the access request from a terminal is, for example, a name-resolving request that requires searching for an IP address based on a given domain name, the notifying unit responds to the request with the IP address of the network device itself. With this configuration, when a terminal makes a name-resolving request, it is possible to carry out IP communications with the IP address of the network device designated as the connecting destination.

In the network device according to the present invention, when the accepting unit has accepted from the requesting terminal an access request with any given IP address other than the IP address of the network device itself designated as the addressee, the notifying unit responds to the access request with the IP address designated by the access request as the transmission-origin IP address instead of the IP address of the network device itself, and provides data that the network device itself holds.

With the configuration described above, if the access request from a terminal designates any given IP address, the notifying unit feigns the IP address of the transmission origin in responding to the access request and returns a response, in place of the connecting destination so that the terminal determines the aforementioned response to be a response from the connecting destination. This configuration makes it possible to establish IP communications with the network device as the communication partner even when the terminal makes an access request with any given IP address designated. Therefore, the configuration enables the network device to provide the terminal with predetermined data such as settings information.

In the network device according to the present invention, when the accepting unit has accepted from the requesting terminal an access request with the IP address of the network device designated as the addressee, the notifying unit provides data held by the network device itself.

With the configuration described above, when a terminal that has received a response to the name-resolving request makes an access request with the IP address of the network device designated as the addressee, it is possible to provide the terminal with data that the network device itself holds. Further, providing a terminal with data that a network device holds is also possible in instances in which the network device's own IP address is designated by the terminal. In particular, if the earlier-described means and the present means are utilized in tandem, a terminal can be provided with data the network device itself holds, no matter what IP address is designated.

In the network device according to the present invention, the notifying unit provides display information that can be displayed on the requesting terminal.

The configuration described above enables the notifying unit to provide display information to be displayed on the display unit of the terminal, making it possible to, for example, automatically display the network-device settings information on the terminal. Thus, by means of the displayed content the user can carry out confirmation, input, and similar operations.

A network device involving the present invention is furnished with an operation unit that enables operation by a user, with the operation unit generating a starting event according to a predetermined operation.

Accordingly, by having user operation be a starting event, confirmation of a user's intention to start an IP connection is made possible.

A network device involving the present invention is furnished with: a relay unit for relaying packets transmitted/received between a terminal connected to a predetermined network and an apparatus connected to another network different from the predetermined network, and a switching unit that carries out a switching process whereby a relay mode, in which the relay unit is actuated and also the distributing unit is actuated, is switched with a non-relay mode in which the relay unit is not actuated, nor is the distributing unit actuated, wherein the distribution control unit actuates the distributing unit when a starting event is generated, regardless of the switching status of the relay mode and the non-relay mode according to the switching unit.

In a case where a network device has such mode switchover function (a so-called router-bridge switchover function), neither the network device nor a terminal within the LAN is able to figure out the IP address of each other, making it impossible to perform IP communications between them when the mode-switching function is changed to a non-relay mode (a bridge mode) in which no packets are relayed between different networks. The network device according to the present invention is, however, configured so that the distribution control unit sets at least the functionality of the distributing unit to be operative regardless of the switchover state. Therefore, it is possible to realize IP communications between the network device and the terminal even when the non-relay mode is selected.

A method of controlling a network device used connected to a network, the network-device control method including: the network device assigning, based on the generation of a predetermined starting event, an IP address to a terminal being another network device connected to the network device itself, and distributing the IP address to the terminal; the network device accepting from the terminal an access request for accessing an arbitrary other network device; and the network device, when having accepted the access request, notifying the terminal of information for accessing the network device itself, regardless of the content of the given access request.

A recording medium according to the present invention is a computer-readable non-volatile recording medium on which is recorded a program for controlling a network device used connected to a network, the program for causing the network device to execute: a distribution step of assigning, based on the generation of a predetermined starting event, an IP address to a terminal being another network device connected to the network device, and distributing the assigned IP address to the terminal; an accepting step of accepting from the terminal an access request for accessing an arbitrary other network device; and a notification step of, when the access request has been accepted in the accepting step, notifying the terminal of information for accessing the network device, regardless of the content of the given access request.

### BRIEF DESCRIPTION OF THE DRAWINGS

FIG. 1 is an explanatory diagram representing a network system 21 built using an access point AP as a first embodiment of a network device;

FIG. 2 is an explanatory diagram illustrating a simplified configuration of the access point AP;

FIG. 3 is an explanatory diagram illustrating a simplified configuration of a wireless terminal TE;

FIG. 4 is a flowchart representing procedural flows of a connection-setting process executed by the access point AP;

FIG. 5 is a flowchart representing procedural flows of a temporary connection preparation process in the connection setting process;

FIG. 6 is a flowchart representing procedural flows of a temporary connection setting process in the connection setting process;

FIG. 7 is a flowchart representing procedural flows of a connection recovery process in the connection setting process;

FIG. 8 is a flowchart representing procedural flows of a configuration process in the connection setting process;

FIG. 9 is a flowchart representing procedural flows of a first settings-information transmission process in the configuration process;

FIG. 10 is a flowchart representing procedural flows of a second settings-information transmission process in the configuration process;

FIG. 11 is an explanatory diagram illustrating a simplified configuration of a network-attached storage NAS as a second embodiment of the network device; and

FIG. 12 is a flowchart representing procedural flows of a simple settings process executed by the network-attached storage NAS.

### DETAILED DESCRIPTION OF THE INVENTION

### A. First Embodiment

### A-1. Configurational Outline of Network System 21

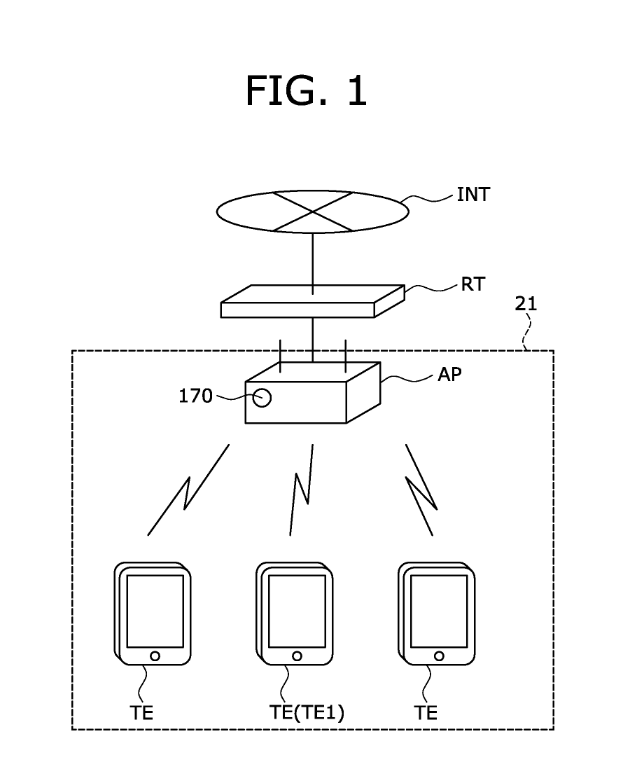

FIG. 1 represents one example of the configurational outline of a network system 21 built using an access point AP as a network device. The present embodiment is configured so that the network system 21 is built using a wireless local area network (LAN) in compliance with IEEE802.11. As shown in FIG. 1, the network system 21 includes an access point AP and a wireless terminal TE. Further, the access point AP is connected to a router RT provided with a broadband router function via a wired cable such as an Ethernet (registered trademark) cable and is connected to the Internet INT. It will be appreciated that there may be a plurality of wireless terminals TE in the network system 21. A plurality of wireless terminals TE is connectible to Internet INT simultaneously via the access point AP.

The access point AP relays wireless communications from the wireless terminal TE. The access point AP is connected to Internet INT via the router RT. In the present embodiment the access point AP supports a process (termed a “connection settings process” below) of readily furnishing the wireless terminal TE with settings information, including encryption settings and authentication information, for carrying out communications secured at a predetermined level.

The access point AP includes a simple setting button 170 as an operation unit. The simple setting button 170 is for use in giving a starting instruction of a connection setting process to the access point AP.

In the present embodiment, the wireless terminal TE is a general-purpose mobile telephone furnished with a display and a wireless communications interface. It should be understood that the category of device as the wireless terminal TE is not particularly limited. It is sufficient that the wireless terminal TE be furnished with a display and a wireless communications interface; the terminal may be, for example, a personal computer, a personal digital assistant (PDA), a portable game console, etc.

The access point AP may be made capable of switching between operative and inoperative a router function thereof that relays communications between two networks. In this case, if a router RT exists on the Internet INT side (i.e., on the wide area network (WAN) side), the router function is switched off. In contrast, if no router function exists, the router function RT is switched on to relay communications between the network system 21 and Internet INT. The present embodiment is configured to connect the router RT to the access point AP, and therefore, the router functionality is switched to be inoperative. It may alternatively be configured so that such switchover of the router function is automatically performed by the access point AP determining whether a router RT exists on the Internet INT side (i.e., the WAN side). This functionality makes it possible to prevent existence of a plurality of routers in the network system. Network address translation (NAT) is typically carried out between the WAN side and the LAN side of a router, and therefore, in using a network application that requires requesting connection through the WAN side, it is often the case that port-forwarding settings are carried out on the router with universal plug and play (UPnP) or the like. Here, in the case of using a plurality of routers, port-forwarding is not set in an upper-level router even if port-forwarding is set in a lower-level router, and therefore, no connection through the WAN side can be established. Provision of automatic switchover of the router function makes it possible to prevent occurrence of the above-described problem even if a user is not specifically aware of it.

Here, an access point AP is enabled to provide a wireless terminal TE with settings information in response to a simple user operation. The following is the description of a configuration for the access point AP to provide the wireless terminal TE with settings information.

### A-2. Configurational Outline of Access Point AP

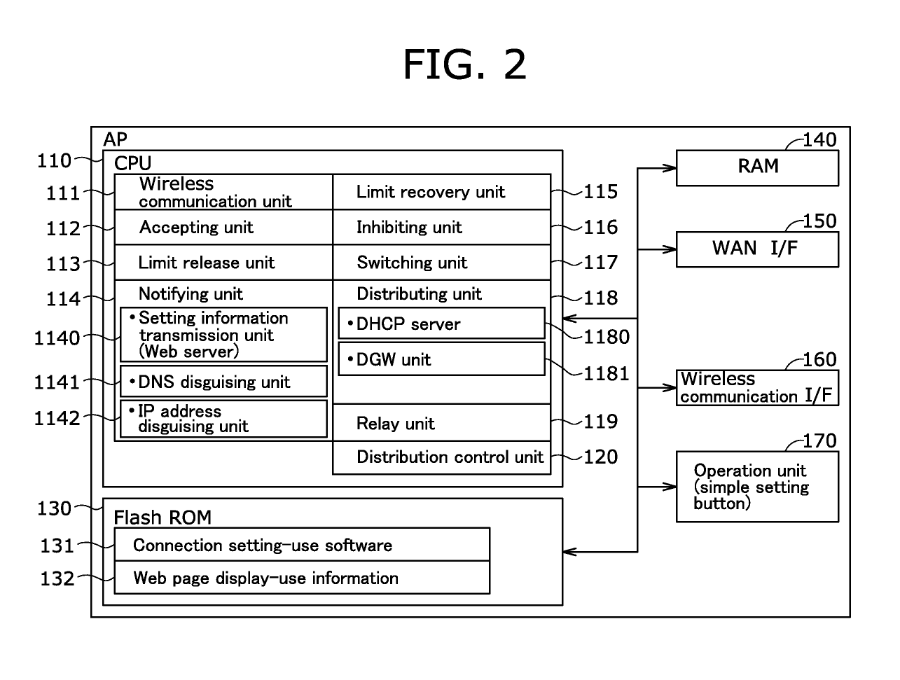

FIG. 2 represents the configurational outline of an access point AP. As shown in FIG. 2, the access point AP includes a central processing unit (CPU) 110, flash read only memory (ROM) 130, random access memory (RAM) 140, a WAN interface (I/F) 150, a wireless communication I/F 160, and a simple settings button 170 that is an operation unit. The aforementioned CPU 110 and components are interconnected via a bus.

By loading into the RAM 140 and executing firmware and associated programs stored in the flash ROM 130, the CPU 110 controls the overall operations of the access point AP. And by executing such programs, the CPU 110 functions as a wireless communications unit 111, an accepting unit 112, a restriction releasing unit 113, a notifying unit 114, a restriction restoring unit 115, a prohibiting unit 116, a switching unit 117, a distributing unit 118, a relay unit 119, and a distribution control unit 120. These functional units will be described in detail later.

Software 131 for making connection settings is recorded on the flash ROM 130. The connection settings software 131 is a program used to configure the wireless terminal TE with settings information generated by the access point AP. The connection settings software 131 is transmitted to the wireless terminal TE and is executed thereon. Connection settings software 131 is prepared per category of operating system (OS) in advance consideration of a plurality of OSs possibly used for wireless terminals TE. Such OSs include, for example, iOS, Android (registered trademark of Google Inc.), and Windows (registered trademark of Microsoft Corp.). It will be appreciated that the “OS category” may include a concept comprehending differences among versions of an OS. Further, information 132 for displaying webpages is recorded on the flash ROM 130. The webpage display information 132 is used to display, in a Web browser, a settings screen used for variously setting the access point AP. The webpage display information 132 is transmitted, by a (later-described) settings information transmission unit 1140 that is one function of the notifying unit 114, to a Web browser 211 on the wireless terminal TE and is used for displaying the setting screen of the access point AP.

The WAN interface (I/F) 150 is an interface for connecting the access point AP to an external network by way of a fixed line. In the network system 21 shown in FIG. 1, the WAN I/F 150 is connected to the LAN side of the router RT. The wireless communication I/F 160 is a control circuit for carrying out wireless communications in compliance with a wireless LAN standard and includes hardware such as a modulator, an amplifier, and an antenna. The wireless communication I/F 160 is controlled by the wireless communications unit 111 of the CPU 110.

The simple setting button 170 is a button for a user to give the access point AP an instruction to start a connection setting process. It will be appreciated that an interface for accepting an instruction to start the connection setting process from the user is not limited to a button. Such interface may be, for example, a graphic user interface (GUI) provided that the access point AP has a display. Alternatively, the interface may be a contact-type or noncontact-type integrated circuit (IC) card, or means that uses an infrared communication. That is, the interface may be configured as input means that allows the user to directly give the access point AP an instruction to start a connection setting process in the mode of the user directly touching or that of short-range communications from nearby the access point AP. Such configuration makes it possible to prevent an ill-intentioned third party from giving the access point AP an instruction to start a connection setting process against the intent of the user of the access point AP. From this viewpoint, shorter ranges over which an instruction to start the connection settings process can be given to the access point AP are the more desirable. The aforementioned range is, for example, desirably within 10 m from the access point AP, and more desirably within 5 m, and further desirably within 1 m. The most desirable configuration of the range is zero meters (0 m)—that is, a configuration with which the user is allowed to give the access point AP an instruction to start the connection setting process only when the user touches the access point AP.

The access point AP is able to perform wireless communications in a restricted state. A “restricted state” is a state in which a wireless terminal TE connecting to the access point AP is restricted. Restriction on a connecting wireless terminal TE can be implemented in a variety of forms. Once a wireless terminal TE has been restricted in some way, the access point AP can be said to be in a restricted state. In the present embodiment, the wireless communications unit 111 has, as functionality for restricting a connecting wireless terminal TE, an ANY connection refusal function, and a service set identifier (SSID) concealment function. The ANY connection refusal function is a function that refuses a connection request, from a wireless terminal TE, in which the SSID is blank or that has been configured as “ANY.” The SSID concealment function is a function according to which SSIDs (herein, extended service set identifiers (ESSIDs)) are not contained in the beacons periodically transmitted from the access point AP. By means of these functions, wireless terminals TE connecting to the access point AP are limited to wireless terminals TE of users who know the ESSID that the access point AP is configured with—that is, to wireless terminals TE in which the same ESSID as the ESSID that the access point AP is configured with has been set.

The wireless communications unit 111 controls communications with a wireless terminal TE connected to the access point AP that are carried out by radio. The accepting unit 112 carries out acceptance of packets transmitted from the wireless terminal TE. The restriction release unit 113, in instances where the wireless terminals TE able to connect to the access point AP are restricted, controls the wireless communications unit 111 to momentarily enable connection access regardless of the wireless terminal TE it is from. In instances where connection access to the access point AP regardless of the wireless terminal TE it is from has been rendered possible by the restriction releasing unit 113, the restriction restoring unit 115 reverts back to a state in which originally connectible wireless terminals TE are restricted. When a connection has been established between the access point AP and a single wireless terminal TE, the prohibiting unit 116 prohibits another wireless terminal TE from newly establishing a connection with the access point AP.

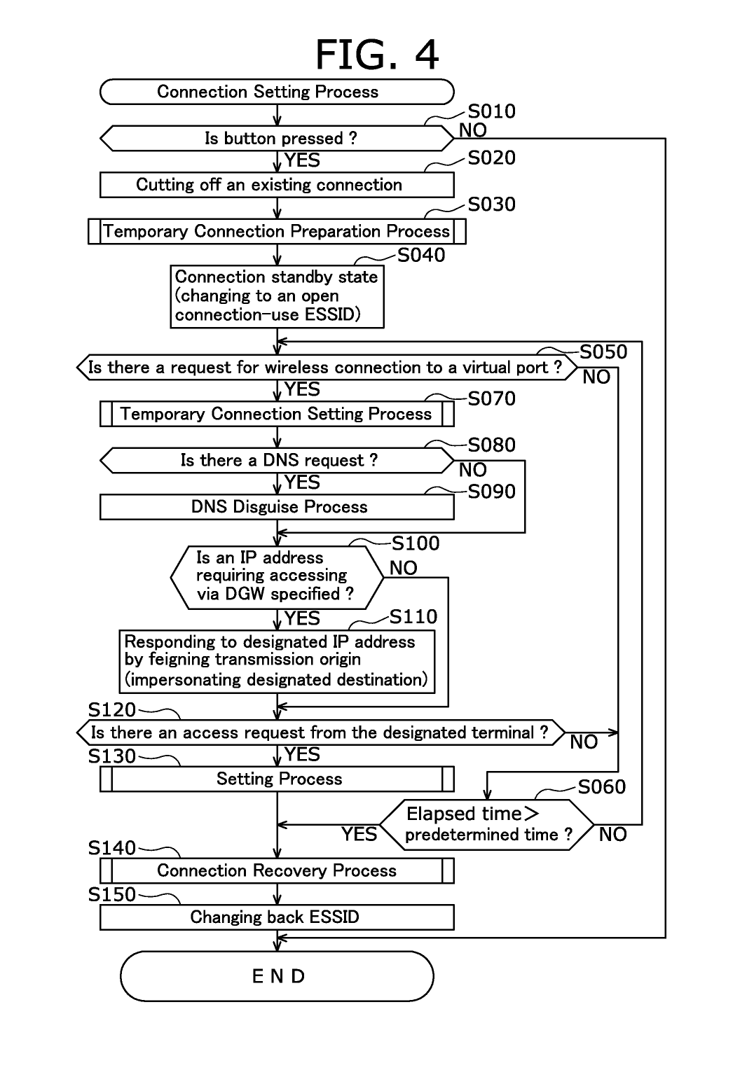

The notifying unit 114 functions as a settings information transmission unit 1140, a domain name system (DNS) disguising unit 1141 and an IP address disguising unit 1142. The settings information transmission unit 1140 has a Web server function, for example. In instances where from a Web browser 211 running on a wireless terminal TE connected to the access point AP there has been a data acquisition request designating, through Hypertext Transfer Protocol (HTTP), the access point AP itself, the settings information transmission unit 1140 transmits the webpage display information 132 stored in the flash ROM 130 to the Web browser 211. Based on the webpage display information 132, the Web browser 211 displays the settings screen for the access point AP on a display unit 250 in the wireless terminal TE. The DNS disguising unit 1141 has functionality that in response to an inquiry from another device for name resolution through DNS returns the IP address of the access point AP itself at all times. Herein, “DNS” refers to a mechanism for converting into an IP address a domain name used for identifying a device connected to the Internet. Employing a program called a DNS client, the wireless terminal TE transmits to a DNS server name-resolving requests for converting domain names into an IP address, and the DNS server responds to the DNS client with an IP address corresponding to the domain name for which a name-resolving request has been made. The IP address disguising unit 1142 has functionality whereby with respect to a wireless terminal TE from which packets designating the access point AP as a default gateway (DGW) have been transmitted, the access point AP carries out a response disguised as the response of an access destination device. Herein, a “DGW” means a device designated as a packet transmission destination when packets are transmitted from a terminal on the LAN side if a communication path in order for the packets to arrive at the access destination device is unknown. If the DGW receives packets from the aforementioned wireless terminal TE, it transfers the packets to an apparatus connected to the WAN side. The details of the processes performed by the DNS disguising unit 1141 and the IP address disguising unit 1142 are set forth in the procedural flows of FIG. 4.

The distributing unit 118 functions as a Dynamic Host Configuration Protocol (DHCP) server 1180 and a DGW unit 1181. In response to a request from a DHCP client on a wireless terminal TE connected to the access point AP, the DHCP server 1180 transmits to the wireless terminal TE information containing an IP address assigned to the wireless terminal TE. The DGW unit 1181 functions as a just-described DGW.

The relay unit 119 has a network address translation (NAT) function, that is, a function that converts between the local IP address of a wireless terminal TE connected to the wireless communications I/F 160 and the global IP address of a device connected to Internet INT. Further, the relay unit 119, employing a routing function, relays packets between the WAN I/F 150 and the wireless communications I/F 160 in accordance with a routing table. The switching unit 117 has functionality to switch the access point AP between a relay mode, in which the functioning of the relay unit 119 is rendered operative and at the same time the functioning of the distributing unit 118 is rendered operative, and a non-relay mode, in which the relay unit 119 functioning is rendered inoperative and the distributing unit 118 functioning is rendered inoperative. Herein, the relay mode is equivalent to the case of the just-described router function being switched on, while the non-relay mode is equivalent to the case of the just-described router function being switched off. In the present embodiment, because a router RT is connected to the access point AP, the switching unit 117 puts the access point into non-relay mode. The distribution control unit 120 controls the distributing unit 118 to render the functioning of the distributing unit 118 operative or inoperative regardless of switchover state by the switching unit 117.

The access point AP supports the multiple SSIDs. That is, the access point AP enables a single physical access point AP to operate as a virtual access point that is a plurality of logical access points. With the access point AP, SSIDs may be established on a per-virtual-access-point basis. Such access points are termed “virtual ports” in the present specification. If the CPU 110 detects that the simple setting button 170 has been pressed, it sets up new virtual port with “!ABC” being the ESSID. Ordinarily the ESSID is contained in the beacons that the access point AP transmits. Therefore, a wireless terminal TE having received a beacon is able, even without having the particular specifications, to transmit to the access point AP a connection request with “!ABC” being the ESSID. In other words, when the access point AP detects the pressing of the simple setting button 170, it puts the virtual port into a non-restricted state in which no restriction is placed on the target for connection to the access point AP. The virtual port is utilized in the connection settings process.

It should be noted that having the post-change ESSID be “!ABC” is in order that in situations where on the wireless terminal TE a plurality of access points are detected by means of a passive scan or active scan, the access point AP (virtual port) will be displayed at the uppermost level in a list displaying the detected access points. The access-point display list on the wireless terminal TE is often displayed arranged in ASCII code sequence. The fact that the “!” is the next-smallest ASCII code after the space symbol means that when a user, in a later-described connection settings process, employs a wireless terminal TE to carry out an operation for establishing a connection relationship between the wireless terminal TE and the access point AP, the user will be able to find the access point AP easily on the display list. User convenience is improved as a result. Thus, it is desirable to set the post-change ESSID to a value whereby it is placed in an upper level on the display list.

### A-3. Configurational Outline of Wireless Terminal TE

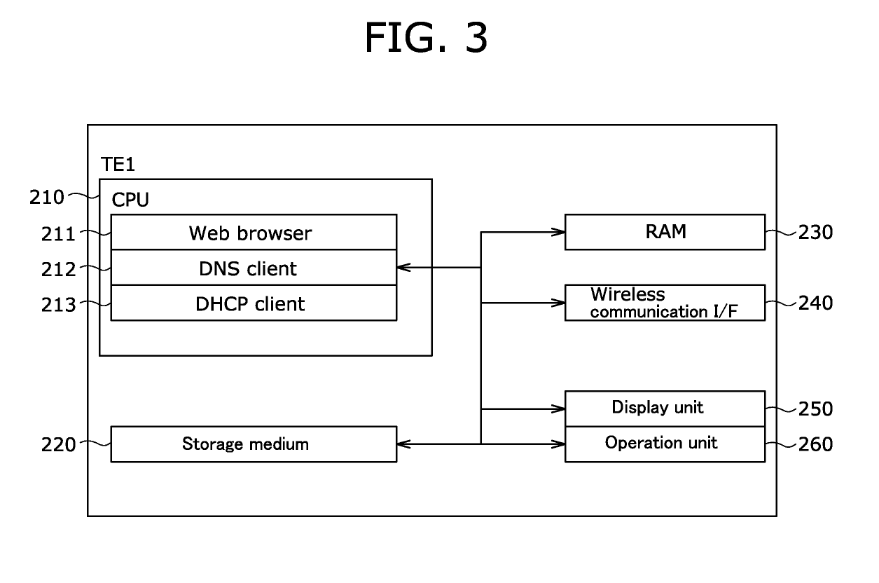

FIG. 3 shows the outline configuration of a wireless terminal TE. Referring to FIG. 3, the wireless terminal TE includes, as hardware, a CPU 210, a storage medium 220, RAM 230, a wireless communication I/F 240, a display unit 250, and an operation unit 260. The CPU 210 develops a program on the RAM 230, the program stored on the storage medium 220, and executes the program, thereby controlling the entire operation of the wireless terminal TE. Here, the storage medium 220 comprehends, for example, a magnetic storage medium, such as a hard-disk drive, and a semiconductor non-volatile storage medium such as a solid state drive (SSD). The display unit 250 is, for example, a display and a graphic chip, and displays a screen for prompting a user operation by means of a graphic user interface (GUI) and a result of processing of the CPU 210. The operation unit 260 accepts a user input and transmits the input information to the CPU 210. The operation unit 260 comprehends, for example, a key board, a mouse and a touch panel.

A Web browser 211 that is a program executed by the CPU 210 obtains data by performing communications, using HTTP, with a Web server program operating on an external electronic device via the wireless communication I/F 240, in response to a user input to the operation unit 260. Then the Web browser 211 displays the obtained data on the display unit 250. Further, a DNS client 212 that is a program executed by the CPU 210 transmits a name-resolving request to a DNS server via the wireless communication I/F 240 and receives from the DNS server an IP address corresponding to the host name and the domain name.

Meanwhile, when the wireless communication I/F 240 establishes communication on a data link layer, a DHCP client 213 that is a program executed by the CPU 210 broadcasts a DHCP discovery packet and receives a DHCP provision packet from a DHCP server 1180 existing on the network. Then the DHCP client 213 transmits a DHCP request packet and receives a DHCP acknowledgement packet from the DHCP server 1180. Thereafter in response to information transmitted from the DHCP server 1180, the DHCP client 213 sets the IP address, the DGW and the DNS server.

### A-4. Connection Setting Process

A connection setting process executed at an access point AP is described here. The connection setting process is performed by an access point AP to provide a wireless terminal TE with setting information for carrying out wireless communications in a network system 21 with a predetermined level of security. FIG. 4 shows procedural flows of the connection setting process.

1. Cutting Off Existing Connection

In the connection setting process, when the CPU 110 included in the access point AP detects pressing of the simple setting button 170 as a process by the accepting unit 112 (Yes for step S010; also simply noted “S010” hereinafter), the CPU 110 executes an existing connection cutoff process (S020) to cut off all connections including the existing wireless connections (including an IP communication connection associated with the cutoff of the wireless connection) established between the access point AP and the wireless terminal TE as well as the IP communication connection between the access point AP and the router RT. If the CPU 110 detects no pressing of the simple setting button 170 (No for S010), it ends the process. Once cutting-off of the existing wireless connections with the wireless terminal TE, newly establishing of a wireless connection with a predetermined wireless terminal(s) TE and transmitting of information such as an IP address from the DHCP server 1180 make it possible to accomplish the purpose of a connection setting process that facilitates transmitting/receiving of information between the access point AP and a wireless terminal TE with which the wireless connection is established.

2. Establishment of New Connection with Designated Terminal TE1

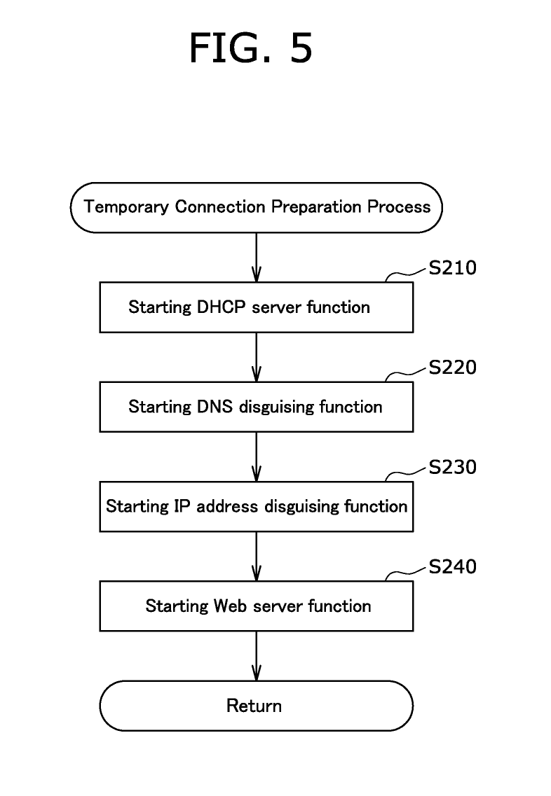

After step S020, the CPU 110 performs a temporary connection preparation process (S030). With the temporary connection preparation process, a temporary connection is enabled for performing a connection setting process. The temporary connection preparation process (S030) is described with reference to FIG. 5.

In the temporary connection preparation process, the distribution control unit 120 sets the distributing unit 118 to be operative. This will actuate the DHCP server 1180 (S210). The DHCP server 1180 makes it possible to set an IP address to a wireless terminal TE with which a wireless connection is established. This enables IP communications between the access point AP and the wireless terminal TE with which the wireless connection is established. Further, the functionality of the DHCP server 1180 makes it possible to distribute setting information for specifying a DNS server to the wireless terminal TE with which the wireless connection is established. Furthermore, the functionality of the DHCP server 1180 makes it possible to distribute setting information for designating a DGW to the wireless terminal with which the wireless connection is established.

Next, the CPU 110 actuates a DNS disguising function (S220). The reason is that it is necessary to actuate the function before performing a DNS disguising process in steps S080 through S090. Then, the CPU 110 actuates an IP address disguising function. The reason is that it is necessary to actuate the function before performing an IP address disguising process in steps S100 through S110. Then the CPU 110 actuates a Web server function. The reason is that the Web server function is used in a setting process (S130), and therefore, it is necessary to actuate the function before the setting process. This completes the temporary connection preparation process.

After the temporary connection preparation process (S030), the limit release unit 113 newly disposes a virtual port having an open connection-use ESSID and shifts to a connection standby state (S040). Accordingly in the connection standby state, the virtual port, receiving a request for connection including the open connection-use ESSID from a wireless terminal TE, establishes a connection relationship with the wireless terminal TE that has transmitted the request for connection. For example, a user of the wireless terminal TE is allowed to use it to detect an access point AP, thereby establishing a connection relationship between the wireless terminal TE and the detected access point AP (i.e., the virtual port) on the basis of the user's manual operation. The manual operation in this case includes, for example: the user operating the operation unit 260 by using a GUI displayed on a display that is an example of the display unit 250 of the wireless terminal TE; selecting an access point AP from a list of the detected access points (that is, a list of ESSIDs of the access points in this case); and instructing an operation for connecting the wireless terminal TE to the access point AP. Such operation causes the wireless terminal TE to transmit to the access point AP a request for connection including the open connection-use ESSID of the detected access point AP. In the following descriptions, the time at which a virtual port in a non-limitation state is newly disposed is defined as “limitation release time.”

The access point AP determines whether there is a request for wireless connection made to the virtual port from a wireless terminal TE (S050). If the access point AP determines that there is a request for wireless connection made to the virtual port from the wireless terminal TE (Yes for S050), it applies a temporary connection process (S070) to the wireless terminal TE that has made the request for wireless connection. In the following description, a wireless terminal TE that has transmitted a request for wireless connection to the virtual port is called a designated terminal TE1. In contrast, if the access point AP determines that there is no request for wireless connection made to the virtual port from any wireless terminal TE (No for S050), it measures time since step S010, and stands by to receive a request for wireless connection from any wireless terminal TE (S050) until a predetermined period of time elapses (No for S060).

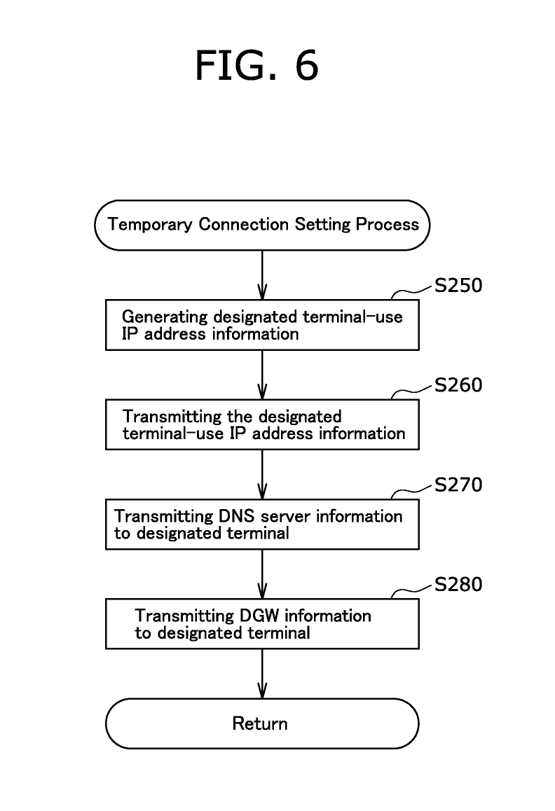

Here, a temporary connection setting process (S070) is described with reference to FIG. 6. In the temporary connection setting process, the DHCP server 1180 generates IP address information to be supplied to the designated terminal TE1 that has established a wireless connection to a virtual port for the access point AP (S250). Further, the DHCP server 1180 transmits the IP address information generated in step S250 to the designated terminal TE1 (S260). The DHCP client 213 of the designated terminal TE1, receiving the IP address information, sets the IP address information to the designated terminal TE1 itself. This enables IP communications between the access point AP and the designated terminal TE1.

Then, the DHCP server 1180 transmits, to the designated terminal TE1 connected to the access point AP, DNS designation information that designates an inquiry destination of a DNS as the access point AP (S270). The DHCP client 213 of the designated terminal TE1, receiving the DNS designation information, registers the IP address of the access point AP as the inquiry destination of the DNS. Then the DHCP server 1180 transmits, to the designated terminal TE1, DGW designation information that designates the access point AP as the DGW (S280). The DHCP client 213 of the designated terminal TE1, receiving the DGW designation information, registers the IP address of the access point AP as the DGW. This completes the temporary connection setting process.

3. Transmission of Access Point AP Settings Information

When a name-resolving request from the designated terminal TE1 is accepted at the access point AP via the virtual port (Yes for S080) after the temporary connection setting process (S070), the DNS disguising unit 1141 performs a DNS disguising process (S090). Here, the DNS disguising process is for notifying of the IP address of the access point AP itself instead of the IP address of an apparatus at the connecting destination when the designated terminal TE1 uses the domain name to inquire of the access point AP about the IP address of the apparatus at the connecting destination. With this functionality, the designated terminal TE1 is enabled to obtain, from the access point AP, information held by the access point AP by using the functionality as a common DNS client 212. After the DNS disguising process (S090), the CPU 110 shifts the process to step S100. In contrast, if no name-resolving request is made from the designated terminal TE1 (No for S080), the CPU 110 shifts the process directly to step S100.

In step S100, the IP address disguising unit 1142 determines whether an IP address is designated for a packet received from the designated terminal TE1, the IP address requiring access to the WAN side by way of the access point AP itself that is the DGW. If determining that the access is to be carried out with the access point AP itself as the DGW (Yes for S100), the IP address disguising unit 1142 feigns the IP address to impersonate the originally designated connecting destination by using the IP address so that the access point AP responds (S110). Then, the IP address disguising unit 1142 shifts the process to step S120. In contrast, if determining that a packet designating the access point as the DGW is not transmitted from a wireless terminal TE (No for S100), that is, if a direct access is carried out with the IP address of the access point AP designated, the IP address disguising unit 1142 shifts the process directly to step S120 without executing the process of step S110.

In step S120, the accepting unit 112 determines whether there has been an access from the designated terminal TE1 that has established a connection relationship with the access point AP (S120). For example, after a wireless terminal TE establishes a connection relationship with the virtual port, the user of the wireless terminal TE uses a Web browser 211 to operate the terminal for connection to a given Uniform Resource Locator (URL), the Web browser installed in the wireless terminal TE. In this case, the wireless terminal TE accesses the access point AP, that is, transmits an HTTP request thereto.

In step S120, if an access is made (Yes for S120), the CPU 110 executes a setting process to add the setting information to the designated terminal TE1 that has made the access (S130). The setting process is described in detail later. If no access has been made (No for S120), the CPU 110 shifts the process to step S060.

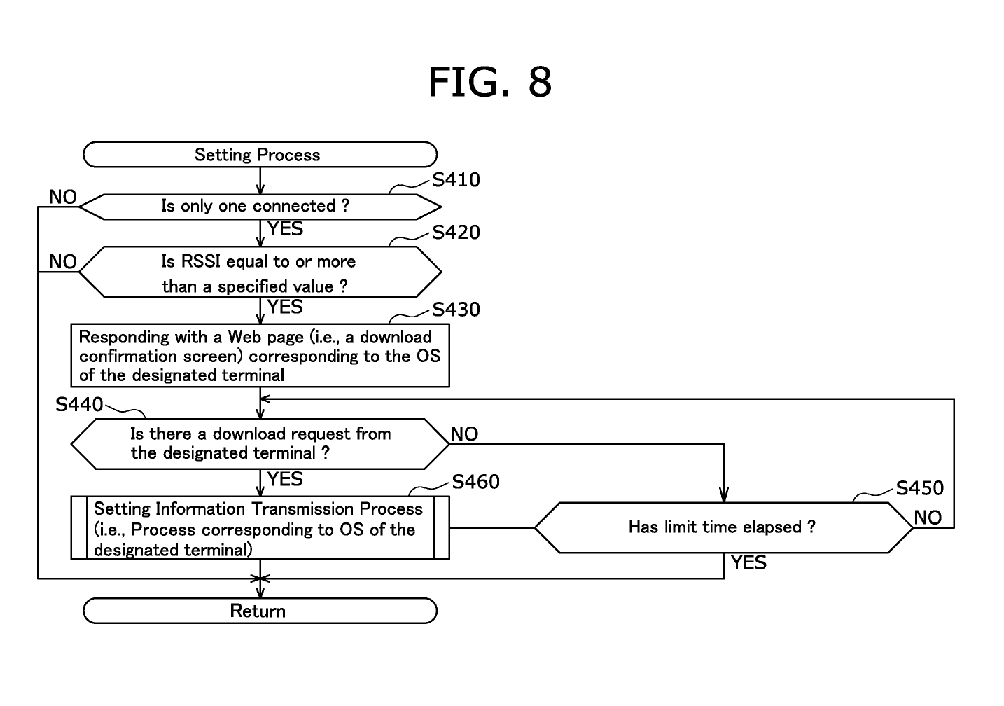

The setting process (the aforementioned S130) is described here. FIG. 8 shows the procedural flows of the setting process. As described above, the starting of the setting process means that a user uses a wireless terminal TE to perform an operation to connect it to the access point AP (i.e., a virtual port) by using a Web browser 211 so that wireless terminal TE transmits an HTTP request. Accordingly the CPU 110 first executes the process of assuming whether the HTTP request has been transmitted, on the basis of an operation of a user having the right authority (such user is also called “legitimate user” hereinafter).

Specifically, when the setting process is started as shown in FIG. 8, the CPU 110 determines whether there is only one designated terminal TE1 that has established a connection relationship with the access point AP within a predetermined period of time since the above described limitation release time (S410). The predetermined period of time may be set as the same period as the limit time of the above described step S060, or set shorter than the limit time of the above described step S060. Note that the CPU 110 may stand by until the predetermined period elapses in a case where it has not elapsed.

In step S410, if there are two or more designated terminals TE1 that have connected to the access point AP (No for S410), there is a possibility of the wireless terminal TE of a user establishing a connection relationship with the access point AP, the user other than the legitimate user, that is, the user with no right authority (such user is also called “illegitimate user” hereinafter). Accordingly, the CPU 110 ends the setting process. That is, the CPU 110 transmits none of the setting information to any designated terminal TE1 that has connected to the access point AP. This configuration makes it possible to restrict provision of any setting information to the designated terminal TE1 of an illegitimate user.

In contrast, if there is only one designated terminal TE1 that has connected to the access point AP (Yes for S410), the connection is assumed to be performed on the basis of the operation of a legitimate user, the user who has pressed the simple setting button 170 of the access point AP. The reason is that the user who has pressed the simple setting button 170 of the access point AP will of course connect thereto. Therefore, the fact that there is one designated terminal TE1 that has connected to the access point AP can be defined as a condition for assuming the legitimacy of the user of a designated terminal TE1. Even in a case where there is only one designated terminal TE1 that has connected to the access point AP, however, there is a small possibility that the designated terminal TE1 of an illegitimate user has connected to the access point AP, instead of the designated terminal TE1 of a legitimate user being connected to the access point AP.

Accordingly, the CPU 110 determines whether a received signal strength indicator (RSSI) of the designated terminal TE1 that has connected to the access point AP is equal to or greater than a specified value (S420) in order to more accurately assume the legitimacy of the user of the designated terminal TE1. A legitimate user is one who has actually pressed the simple setting button 170 of the access point AP, and therefore the user must be close to it. Therefore, the designated terminal TE1 of the legitimate user must be closer to the access point AP than is the designated terminal TE1 of an illegitimate user who has connected to the access point AP from outside. As a result, the RSSI of the designated terminal TE1 of the legitimate user is higher than the RSSI of the designated terminal TE1 of the illegitimate user. Accordingly, the specified value of the RSSI in step S420 is set at a level that would not normally be detected unless a designated terminal TE1 is located closely to the access point AP, and thereby it is possible to correctly assume that a designated terminal TE1 with the RSSI being equal to or greater than a specified value is a legitimate user's and that a designated terminal TE1 with the RSSI being less than the specified value is an illegitimate user's. It will be appreciated that it is possible to assume whether a designated terminal TE1 is a legitimate user's or an illegitimate user's on the basis of the response speed of wireless communication, instead of, or in addition to, the RSSI. For example, the CPU 110 may assume a designated terminal TE1 with the response speed being lower than the specified value to be an illegitimate user's. An illegitimate user is usually outside a room where the access point AP is disposed, and therefore the communications between the designated terminal TE1 of the illegitimate user and the access point AP are performed across a wall of the room, and thus the response speed is reduced.

In step S420, if the RSSI is less than the specified value (No for S420), the designated terminal TE1 connected to the access point AP is possibly an illegitimate user's. Accordingly, the CPU 110 ends the setting process. That is, the CPU 110 transmits no setting information to the designated terminal TE1 with the RSSI being lower than the specified value among the designated terminal TE1 connected to the access point AP. This configuration makes it possible to restrict provision of the setting information to the designated terminal TE1 of an illegitimate user, enabling securing of the security.

In contrast, if the RSSI is equal to or greater than the specified value (Yes for S420), the CPU 110 transmits a Web page to the designated terminal TE1 by a process of the settings information transmission unit 1140 (S430). The Web page to be transmitted is screen data for checking with the user for presence of intention to download setting information. The Web page is stored, as webpage display information 132, on the flash ROM 130 for each of the kinds of OSs possibly operating on a designated terminal TE1, likewise in the case of the above described connection setup-use software 131. The CPU 110 determines a Web page for response, in accordance with the kind of an OS operating on the designated terminal TE1. It is possible to determine the kind of OS operating on the designated terminal TE1 by checking a User Agent included in the HTTP request transmitted from the designated terminal TE1.

As described above, the present embodiment is configured so that, when satisfying two conditions, the CPU 110 transmits a Web page to a designated terminal TE1 that satisfies the conditions, where a first condition is that one designated terminal TE1 is connected to the access point AP and a second condition is that the RSSI of the designated terminal TE1 connected to the access point AP is equal to or greater than a specified value. It may be alternatively configured to adopt only one of the first and second conditions as the condition for the CPU 110 to transmit a Web page.

Having transmitted the Web page, the CPU 110 determines whether a download request is received from the designated terminal TE1 (S440). The download request is transmitted by a user giving an instruction to approve a download on a download confirmation screen displayed on the display of the designated terminal TE1. In step S440, if a download request is not received (No for S440), the CPU 110 stands by to receive it until a predetermined limit period of time elapses (S450). If the limit time elapses without receiving a download request (Yes for S450), the CPU ends the setting process. It will be appreciated that the above described steps S430 through S450 may be eliminated.

In contrast, if a download request is received (Yes for S440), the CPU 110 executes a setting information transmission process as a process by the settings information transmission unit 1140 (S460). The setting information transmission process is for transmitting setting information to the designated terminal TE1. The process is performed in accordance with the kind of the OS operating on the designated terminal TE1. Thus, the setting process ends.

The setting information transmission process (the aforementioned S460) is described here. In the setting information transmission process, different processes are executed dependently on the kind of the OS operating on the designated terminal TE1. The process may be categorized into a first setting information transmission process and a second setting information transmission process. The first setting information transmission process is executed in a case where the OS operating on the designated terminal TE1 has a specification to download a connection setting file in a predetermined form, instead of permitting the download of a communication program. The operating systems of this type include, for example, iOS. The second setting information transmission process is executed in a case where the OS operating on the designated terminal TE1 has a specification to permit the download of a communication program. The operating systems of this type include, for example, Android and Windows.

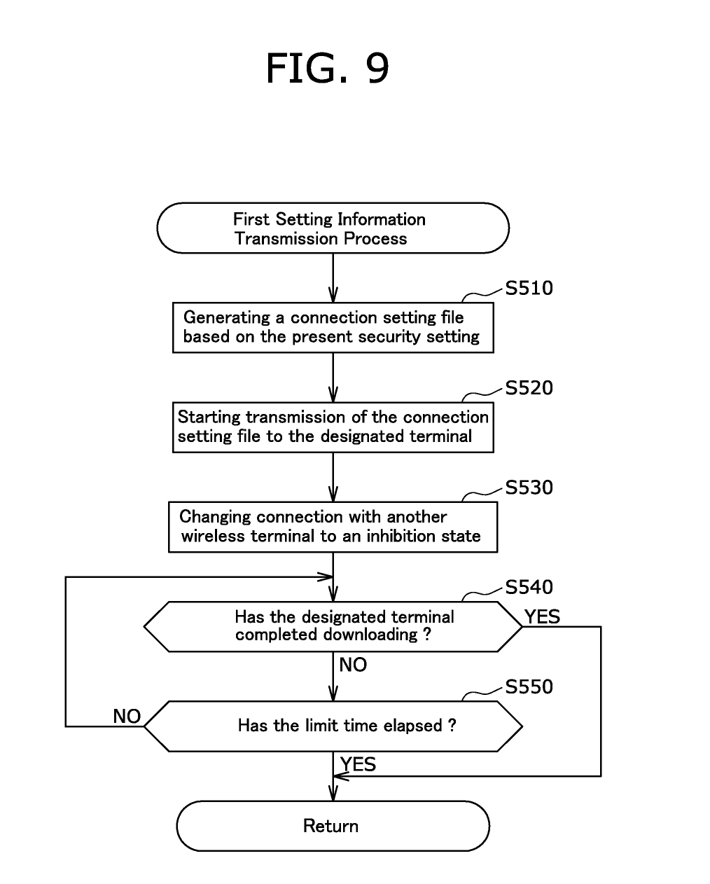

FIG. 9 represents procedural flows of a first setting information transmission process. As shown in FIG. 9, as the first setting information transmission process is started, the CPU 110 first generates a connection setting file on the basis of the current security setting (S510). The connection setting file is a file in an Extensible Markup Language (XML) format and a Hyper Text Markup Language (HTML) format including setting information generated on the basis of the current security setting.

Having generated the connection setting file, the CPU 110 starts transmission of the connection setting file to the designated terminal TE1 as a process by the settings information transmission unit 1140 (S520). Having started the transmission of the connection setting file, the CPU 110 changes, as a process by the inhibiting unit 116, an operation state of the access point AP to a connection inhibition state in which establishing of a connection relationship is inhibited between the access point AP and a wireless terminal TE other than the designated terminal TE1 (S530). Thus changing to the connection inhibition state establishes a connection relationship between the access point AP and another wireless terminal TE other than the designated terminal TE1, making it possible to prevent execution of a new connection setting process. As a result, it is possible to prevent provision of any setting information to a wireless terminal TE other than the designated terminal TE1 to which the setting information is to be provided. Therefore, for example, even if an illegitimate user perceives a legitimate user performing a connection setting for the wireless terminal TE and tries to connect his/her wireless terminal to the access point AP, with any method, by following the performing of the legitimate user, the illegitimate user will be unable to wirelessly connect it to the access point AP, and unable to obtain any setting information as a result.

Having changed the access point AP to the connection inhibition state, the CPU 110 determines whether the download of the connection setting file has been completed on the designated terminal TE1 (S540). In step S540, if the download has been completed (Yes for S540), the CPU 110 ends the first setting information transmission process. In contrast, if the download has not been completed (No for S540), the CPU 110 stands by for the completion of the download until the time from starting the transmission of the connection setting file reaches the limit time (No for S550).

If the limit time has elapsed without completing the download (Yes for S550), the CPU 110 cancels the transmission of the connection setting file and ends the first setting information transmission process. As a result, the virtual port is recovered from a non-limitation state to a limitation state in step S140. This configuration prevents an illegitimate user's access, when it takes a long time to download a connection setting file due to, for instance, an adverse condition of the communication environment, thereby making it possible to enhance the security. The process of step S550, however, may be eliminated. Further, the limit time for step S550 may be determined with the limitation release time specified as the starting point as in the case of the above described step S060. In this case, the limit time for step S550 may be the same limit time as that determined for the above described step S060 or longer than that.

When a connection setting file is downloaded onto the designated terminal TE1 as a result of the first setting information transmission process, the contents of the connection setting file is displayed on the display of the designated terminal TE1 by the Web browser 211. If the operating system of the designated terminal TE1 is, for example, iOS, the user performs an operation to select setting information from among the displayed contents of the connection setting file, thereby causing the designated terminal TE1 to register the selected setting information with the memory of the designated terminal TE1 itself to set the setting information.

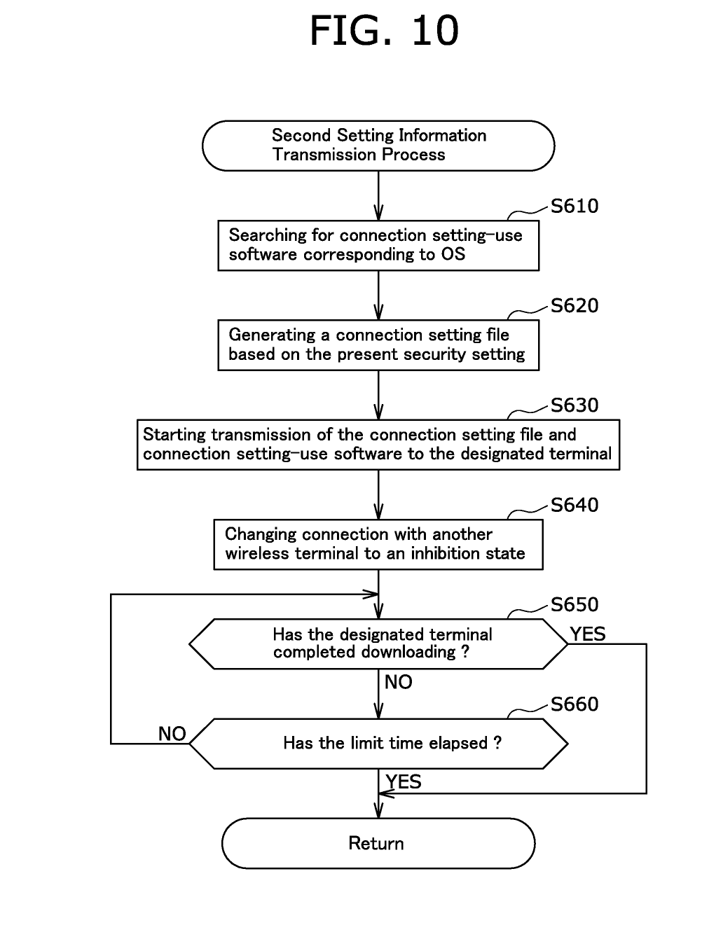

FIG. 10 represents procedural flows of a second setting information transmission process. As shown in FIG. 10, as the second setting information transmission process is started, the CPU 110 first searches a plurality of pieces of connection setting-use software 131 recorded on the flash ROM 130 for connection setting-use software 131 corresponding to the OS operating on the designated terminal TE1 (S610).

Having retrieved the connection setting-use software 131, the CPU 110 generates a connection setting file on the basis of the current security setting (S620). This process is the same as that of the above described step S520 (refer to FIG. 9). Having generated the connection setting file, the CPU 110 starts transmission of the retrieved connection setting-use software 131 and the generated connection setting file to the designated terminal TE1, as a process by the settings information transmission unit 1140 (S630). Having started the transmission, the CPU 110 changes the operation state of the access point AP to a connection inhibition state, as a process by the inhibiting unit 116 (S640). This process is the same as that of the above described step S540.

Having changed the access point AP to the connection inhibition state, the CPU 110 shifts the process to steps S650 and S660. The processes of steps S650 and S660 are the same as those of the above described steps S540 and S550, and therefore the description is not provided here.

When the connection setting-use software 131 and the connection setting file are downloaded onto the designated terminal TE1 as a result of the second setting information transmission process, the content of the connection setting file is displayed on the display of the designated terminal TE1 by the Web browser 211. A screen for checking with the user the applicability of executing the downloaded connection setting-use software 131 is overlapped on the screen displaying the connection setting file. When an operation is performed by the user to instruct execution of the connection setting-use software 131, the software is executed on the designated terminal TE1, and the setting information is set to the designated terminal TE1.

Returning to FIG. 4 at this point, if no access request is made from the designated terminal TE1 within a predetermined period of time from the operation of the simple setting button 170 in the connection setting process (Yes for S060), the CPU 110 performs a connection recovery process (S140). Likewise, the CPU 110 performs the connection recovery process (S140) when completing the setting process (S130).

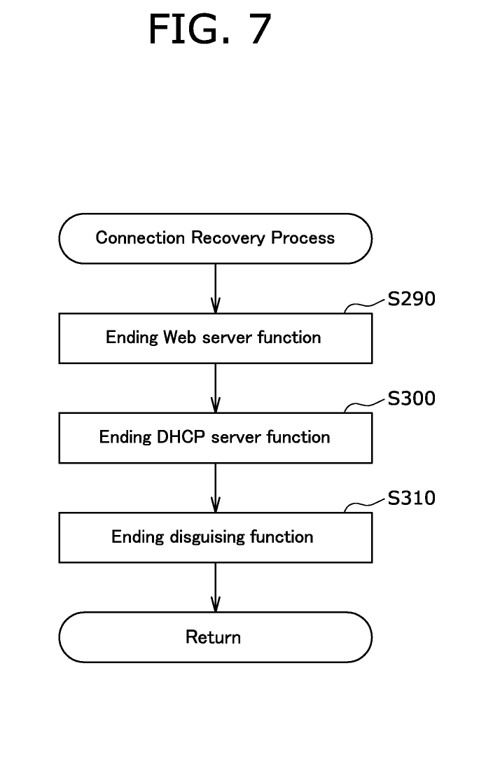

Here, the connection recovery process (S140) is described with reference to FIG. 7. In the connection recovery process, the CPU 110 performs a process to end the Web server function of the settings information transmission unit 1140 (S290). The process makes it possible to reduce a load on the CPU 110. Then, the CPU 110 ends the DHCP server 1180 (S300). Having been actuated in the temporary connection preparation process, the DHCP server 1180 is used for temporarily assigning an IP address to a terminal for performing the connection. Further, in order to perform a DNS disguising process and an IP address disguising process, the DHCP server 1180 perform a process for setting the access point AP as a DNS server and a DGW to the terminal. If the DHCP server 1180 is continuously set to be operative, a situation may arise, in which a connection to the DNS server and the DGW is disabled, the connection that must primarily be enabled. In order to prevent such situation, the DHCP server 1180 is ended to be re-actuated on an as required basis.

Then the DNS disguising process and the IP address disguising process are ended (S310), and so is the connection recovery process.

Referring to FIG. 4, after the connection recovery process (S410), the limit recovery unit 115 erases the connection setting-use ESSID (S150). The limiting of connection with a wireless terminal TE using an open connection-use ESSID to a predetermined period of time makes it possible to enhance the security of the connection.

### A-5. Advantages

With the above described access point AP, the functionality of the distributing unit 118 is switched to be operative in accordance with an operation on the simple setting button 170. Further, IP communications are enabled by distributing an IP address to a designated terminal TE1 to which the DHCP server 1180 of the distributing unit 118 is connected. Further, the DHCP server 1180 transmits, to the terminal, information for designating the access point AP as an inquiry destination for a DNS and as a DGW, thereby allowing the user to set the inquiry destination for a DNS and the DGW to the designated terminal TE1 even if the user is not specifically conscious.

Having received an inquiry about a DNS from the designated terminal TE1, the access point AP responds to the inquiry with the IP address of the access point AP itself, regardless of the domain name designated by the inquiry (refer to S080 and S090 shown in FIG. 4). This process makes it possible to guide, to the access point AP, a Web browser accessing a server on Internet INT using a DNS.

Further, the settings information transmission unit 1140 responds to a terminal by feigning a response from the requested connecting destination, the terminal trying to access from the designated terminal TE1 by designating the access point AP as the DGW (S100 and S110). This process enables the access point AP to transmit setting information even in communications via a connection by directly specifying the IP address instead of performing a name solution using a DNS. A user is allowed to simply connect to the access point AP by using the above described DNS disguising process and IP address disguising process even if the user has no high-level of knowledge about the network.

Further, the user is allowed to simply obtain and input setting information by using the Web browser 211 to connect from the designated terminal TE1 to the access point AP, and by transmitting the setting information from the Web server of the settings information transmission unit 1140 included in the access point AP to the Web browser 211 by a format that can be displayed thereon.

Further, the user's operation of the simple setting button 170 is used as a predetermined starting event, and thereby it is possible to recognize the user's starting the process and smoothly perform the subsequent operations.

Further, the connection is cut off when a predetermined period of time elapses after transitioning to the connection standby state (S060). This configuration limits the time of an open connection state to a predetermined period, making it possible to enhance the security.

Further, the above described access point AP is configured so that the distribution control unit 120 temporarily switches the functionality of the distributing unit 118 to be operative in the temporary connection preparation process (S030), even when operating in the non-relay mode in which the functionality of the relay unit 119 is switched to be inoperative by the switching unit 117 to thereby switch the functionality of the distributing unit 118 to be inoperative. This configuration facilitates an access to the access point AP by the functionality of the distributing unit 118 as those of the DHCP server 1180 and DGW unit 1181, the functionality of the DNS disguising unit 1141, and that of the IP address disguising unit 1142 executing the processes in steps S050 through S100. With this, it is possible to simplify the setting to be carried out by the user for performing the process of setting between a wireless terminal TE and the access point AP in step S130.

The access point AP is configured so as to allow the user to press the simple setting button 170 to change the access point AP (i.e., the virtual port) to a non-connection state, and then operate the wireless terminal TE to establish a connection relationship between the designated terminal TE1 and the access point AP. Furthermore, the user is allowed to set setting information to the designated terminal TE1 just by performing an operation to access any given URL using the Web browser 211. That is, the user, even with an insufficient knowledge about the wireless communication, is allowed to set the setting information to the designated terminal TE1 with just a simple operation. Furthermore, the non-limitation state of the access point AP is recovered to a limitation state by the generation of a predetermined event, for example, elapsing of a predetermined period of time and completion of downloading the setting information, and thereby the security is secured. Further, it is unnecessary to install any specific program in the designated terminal TE1, thus contributing the usability.

### B. Second Embodiment

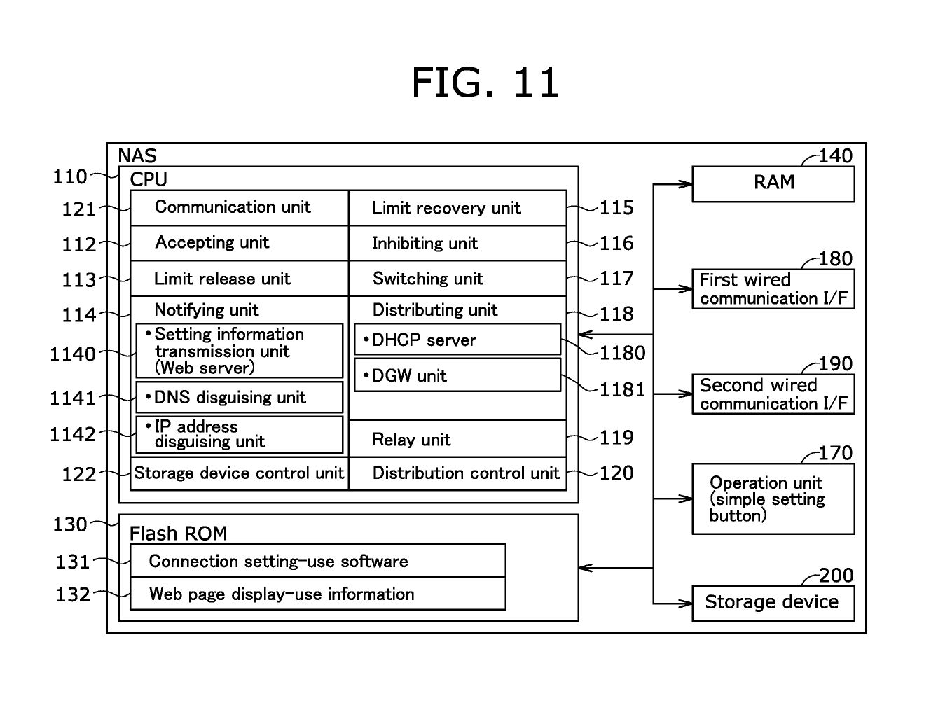

Next, a second embodiment of the network device is described. FIG. 11 shows the outline configuration of a network-attached storage NAS as the second embodiment. The configuration of the network-attached storage NAS is approximately the same as that of the access point AP of the first embodiment.

The network-attached storage NAS is different from the access point AP where the former includes a storage device 200, as shown in FIG. 11. Here, the storage device 200 is, for example, an HDD or an SDD. A CPU 110 has functionality as a storage device control unit 122 disposed for controlling the storage device 200.

The present embodiment further includes a first wired communication interface (I/F) 180 and a second wired communication interface (I/F) 190, in place of the WAN I/F 150 and wireless communication I/F 160. The first wired communication I/F 180 is an interface included also in a typical network device, while the second wired communication I/F 190 is a setting specific interface specifically disposed for the present embodiment. The CPU 110 has functionality of a communication unit 121 disposed for controlling the first and second wired communication I/Fs 180 and 190.

The storage device control unit 122 writes data received from the first wired communication I/F 180 to the storage device 200. The storage device control unit 122 also reads data from the storage device 200 in accordance with an instruction from a terminal connected to the first wired communication I/F 180 and transmits the data to the terminal. The second wired communication I/F 190 includes an interface, for example, an Ethernet port, disposed for connecting a network-attached storage NAS to a designated terminal, and is used for setting the network-attached storage NAS. Here, the designated terminal is defined as a device used for setting a network-attached storage NAS.

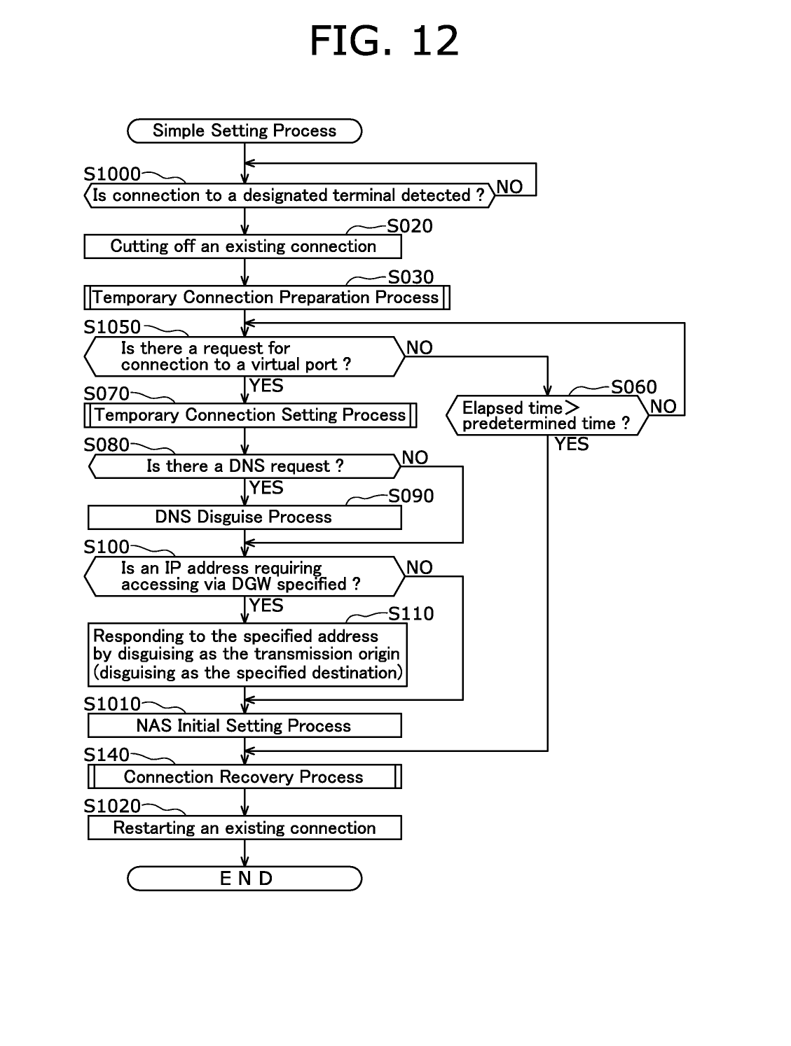

FIG. 12 represents procedural flows of a simple setting process executed by the network-attached storage NAS of the present second embodiment using the second wired communication I/F 190. Note that the same signs as in FIG. 4 are used for the steps in which the same process is performed, and the description is partially not provided.

Referring to FIG. 12, the CPU 110 stands by until a physical connection with the designated terminal (i.e., Linkup) is detected in the second wired communication I/F 190 (S1000). When a Linkup is detected (Yes for S1000), the CPU 110 cuts off (i.e., Linkdown) the existing connection (S020). Here, “the existing connection” is the connection between the network-attached storage NAS and a terminal that are interconnected via the first wired communication I/F 180. The cutoff of the connection makes it possible to prevent an extraneous interrupt process during a setting process, preventing the processing speed from deteriorating and an abnormal ending of the setting process.

Then, the CPU 110 executes a temporary connection preparation process (S030). The temporary connection preparation process enables a temporary connection setting process quickly after connection to the designated terminal. Then the accepting unit 112 determines presence/absence of a request for connection from the designated terminal (S050). If there is no request for connection from the designated terminal (No for S050), the accepting unit 112 waits for a request for connection from the designated terminal until a predetermined period of time elapses (No for S060). Here, when the predetermined period elapses (Yes for S060), the CPU 110 executes the connection recovery process (S140), returns to communications using the first wired communication I/F 180 that is the existing connection (S1020) and ends the simple setting process. The ending of the process when the predetermined period elapses prevents the normal function as the network-attached storage NAS from stopping for an extended period of time.

If there is a request for connection from the designated terminal (Yes for S050), the distributing unit 118 performs the temporary connection setting process (S070). The temporary connection setting process enables IP communications between the network-attached storage NAS and the designated terminal, and enables a DNS disguising process and an IP address disguising process (these are described later). The accepting unit 112 determines whether there is a DNS request from the designated terminal (S080). The destination of the DNS inquiry of the designated terminal is designated as the IP address of the network-attached storage NAS by the aforementioned temporary connection setting process (S070). Therefore, when the designated terminal makes a name-resolving request for the domain name, it inquires of the network-attached storage NAS.

If the accepting unit 112 accepts a name-resolving request from the designated terminal (Yes for S080), the DNS disguising unit 1141 of the network-attached storage NAS performs a DNS disguising process, that is, notifies the designated terminal of the IP address of the network-attached storage NAS itself, instead of the IP address of an original connecting destination to which the designated terminal primarily tries to connect (S090). With the DNS disguising process, the communication destination of the designated terminal turns out to be the network-attached storage NAS. If there is no DNS request after the step S090 or in step S080 (No for S080), the CPU 110 shifts the process to step S100. In step S100, the IP address disguising unit 1142 determines whether an IP address in need of an access to the WAN side via the network-attached storage NAS that is the DGW is designated (S100). Here, if the designated terminal is involved in communications via the network-attached storage NAS as the DGW (Yes for S100), the IP address disguising unit 1142 disguises an IP address to feign the connecting destination to which the designated terminal tries to connect so that the network-attached storage NAS itself communicates with the designated terminal (S110). Meanwhile, if the designated terminal directly access by designating the IP address of the network-attached storage NAS (No for S110), the process is shifted directly to step S1010.

In step S1010, the Web server of the settings information transmission unit 1140 notifies the Web browser 211 used on the designated terminal of information for carrying out an initial setting of the network-attached storage NAS. The user of the designated terminal operates the Web browser 211 to carry out the initial setting, for example, a setting process, such as the account name and the password of an administrator, of the network-attached storage NAS. Then, when the user carries out an operation to end the initial setting, the CPU 110 of the network-attached storage NAS executes the connection recovery process (S140) to restart the existing connection (S1030) and ends the simple setting process. Note that the operation to end the initial setting comprehends, for example, an operation to close the Web browser screen, an operation to select a setting complete icon displayed in the Web browser screen, and an operation to disengage a physical connection between the designated terminal and the second wired communication I/F 190.

As described above, the second embodiment makes it possible to perform a simple setting by using, as a trigger, the physical connection (i.e., a linkup) between a designated terminal and a second wired communication I/F 190 that is the specific port for setting. As such, utilization of a characteristic that is a wired connection further simplifies the work as much as the elimination of a button operation. It will be appreciated that the benefit of needing no specific software and the like is the same as with the first embodiment.

### C. Modification Examples

### C-1. Modification Example 1

A network device has been described as an access point AP in the first embodiment and as a network-attached storage NAS in the second embodiment, whereas it may certainly be another kind of apparatus that is provided with network connectivity. It may be, for example, a camera, a television (TV), and a TV tuner that are provided with network connectivity. Also such cases render benefits of a terminal simply performing the IP connection to a network device, and of the terminal setting, operating, and the like, the network device.

### C-2. Modification Example 2

The connection between a network device and a terminal may be via a wired connection or a wireless connection. If the network device is connected to a terminal via a wired connection, the linkup between a setting-specific port included in the network device and the terminal is handled as a predetermined starting event as described for the second embodiment, and thereby a simple connection with a higher level of security can be realized. Alternatively, the predetermined starting event may be, for example, the timing when a predetermined period elapses after actuating the network device. In this case, a starting event may be reported by a light-emitting diode (LED) or the like to facilitate an intuitive understanding of a starting event for the user.

### C-3. Modification Example 3

The first and second embodiments are configured so that the settings information transmission unit 1140 includes a Web server as a part of the functionality. Such functionality, however, is not limited to examples set forth in the present specification, and rather may use any given device capable of interactively communicating with a wireless terminal or a wired terminal connected to the access point AP, the device, such as a telnet server and a secure shell (SSH) server. In this case, a program operating on a terminal connected to the network device may use a telnet client or an SSH client in place of the Web browser 211.

### C-4. Modification Example 4

A network device is also applicable to a system for monitoring power consumption in a home using the network device and reporting the monitoring result to a terminal. In this case, the network device can be connected via a network or a dedicated bus to an apparatus, such as a power distribution board, the apparatus that is provided with functionality of a power consumption monitor, and that is capable of managing a power usage state. The aforementioned network device is capable of obtaining power usage information from the aforementioned apparatus capable of managing the power usage state. Here, the power usage information may be obtained in response to the above described predetermined starting event, or periodically at predetermined temporal intervals. The case of obtaining the power usage information in response to the predetermined starting event makes it possible to obtain the information with high real-time responsiveness. The case of pre-obtaining the power usage information at the predetermined temporal intervals shortens the processing time between the predetermined starting event and the end of the process.

In the above described configurations, the network device, receiving a trigger that is a predetermined starting event, such as pressing of a button included in the network device itself, causes the DHCP server 1180, DNS disguising unit 1141 and IP address disguising unit 1142 to be set temporarily operative. This configuration enable the Web browser 211, specific software or the like to simply monitor a power state.

In summary, the embodiments of the present invention have been described. The present invention, however, is in no way limited to the embodiments set forth in the above description and rather may be embodied in various manners possible within the scope and spirit of the present invention. For example, the elements disposed in the embodiments corresponding to the components of each means disposed for solving the above described problems may appropriately be combined, eliminated and/or modified in higher levels of concept in modes that are capable of solving at least a part of the aforementioned problems or in modes that render at least a part of the above described effectiveness. Further, the present invention can be realized as, for example, a method for controlling the network device, a program for controlling the network device, an access point device, a method of providing a communication setting, a method of a communication setting, a program for an access point, and a recording medium on which the aforementioned program is recorded, in addition to the network device.

What is claimed is:

1. A self network device for use connected to a network, said self network device comprising:
a distributing unit for assigning an IP address to a terminal being another, non-self network device connected to the self network device, and distributing the assigned IP address to the terminal, and for notifying the terminal to transmit all access requests to said self network device;
a distribution control unit for actuating said distributing unit based on the generation of a predetermined starting event;
an accepting unit for accepting any given access request from the terminal; and
a notifying unit for, if said accepting unit has accepted a given access request from the terminal after said distributing unit has been actuated, notifying the terminal of information for accessing said self network device, regardless of the content of the given access request.

2. The self network device according to claim 1, wherein if said accepting unit has accepted a name-resolving request from the requesting terminal as the given access request, said notifying unit notifies the terminal of information including the IP address of said self network device as said accessing information.

3. The self network device according to claim 1, wherein if said accepting unit has accepted from the terminal an access request designating as the addressee any given IP address other than the IP address of said self network device, the notifying unit answers the access request by having the IP address designated by the access request be the IP address of transmission origin instead of the IP address of said self network device, and provides data held by said self network device to the terminal.

4. The self network device according to claim 3, wherein if said accepting unit has accepted from the terminal an access request designating the IP address of said self network device as the addressee, said notifying unit provides data held by said self network device to the terminal.

5. The self network device according to claim 3, wherein said notifying unit provides the terminal with display information that can be displayed on the terminal.

6. The self network device according to claim 3, further comprising a user-operable operating unit, said operating unit for generating said starting event according to a predetermined operation.

7. The self network device according to claim 3, further comprising:
a relay unit for relaying packets transmitted/received between a terminal connected to a predetermined network and an apparatus connected to another network different from the predetermined network; and
a switching unit for switching said self network device between a relay mode in which said switching unit actuates said relay unit together with said distributing unit, and a non-relay mode in which said switching unit does not actuate said relay unit and does not actuate said distributing unit; wherein
when said starting event is generated, said distribution control unit actuates said distributing unit irrespective of the state of switching by the switching unit between the relay mode and the non-relay mode.

8. The self network device according to claim 1, wherein if said accepting unit has accepted from the terminal an access request designating the IP address of said self network device as the addressee, said notifying unit provides data held by said self network device to the terminal.

9. The self network device according to claim 1, further comprising a user-operable operating unit, said operating unit for generating said starting event according to a predetermined operation.

10. The self network device according to claim 1, comprising
a relay unit for relaying packets transmitted/received between a terminal connected to a predetermined network and an apparatus connected to another network different from the predetermined network; and
a switching unit for switching said self network device between a relay mode in which said switching unit actuates said relay unit together with said distributing unit, and a non-relay mode in which said switching unit does not actuate said relay unit and does not actuate said distributing unit; wherein
when said starting event is generated, said distribution control unit actuates said distributing unit irrespective of the state of switching by the switching unit between the relay mode and the non-relay mode.

11. A method of controlling a self network device used connected to a network, said self network-device control method comprising:
said self network device assigning, based on the generation of a predetermined starting event, an IP address to a terminal being another network device connected to said self network device, and distributing the IP address to the terminal;
said self network device accepting from the terminal an access request for accessing any given other network device; and
said self network device, when having accepted the access request, notifying the terminal of information for accessing said self network device, regardless of the content of the access request.

12. A computer-readable non-volatile recording medium on which is recorded a program for controlling a self network device used connected to a network, the program for causing the self network device to execute:
a distribution step of assigning, based on the generation of a predetermined starting event, an IP address to a terminal being another network device connected to said self network device, and distributing the assigned IP address to the terminal;
an accepting step of accepting from the terminal an access request for accessing any given other network device; and
a notification step of, when the access request from the terminal has been accepted in said accepting step, notifying the terminal of information for accessing said self network device, regardless of the content of the access request.

13. A network access point comprising:
a start-instruction accepting interface for accepting a connection-settings process start instruction; and
a central processing unit (CPU) configured with
distributing-unit circuitry for causing the CPU to function as a conditionally operable distributing unit assigning an IP address to a terminal wirelessly accessing the network access point, and delivering the assigned IP address to the wirelessly accessing terminal,
control circuitry for actuating the conditionally operable distributing unit function of the CPU in response to a start instruction accepted through said start-instruction accepting interface,
acceptance-unit circuitry for causing the CPU to function as a conditionally operating acceptance unit accepting any given access request from a wirelessly accessing terminal, conditional upon said distributing unit being actuated, and
notifying-unit circuitry for causing the CPU to function as a notifying unit sending to a wirelessly accessing terminal, in response to said acceptance unit accepting an access request from the terminal and irrespective of the content of the access request, information enabling the terminal to access the network access point.
